(19) United States
(12) Patent Application Publication
(10) Pub. No.: US 2009/0189671 A1
(43) Pub. Date: Jul. 30, 2009

(54) Method and Apparatus for Improvement of Matching FET Currents Using a Digital to Analog Converter

(76) Inventors: Steven John Baumgartner, Zumbro Falls, MN (US); David W. Siljenberg, Byron, MN (US); Dana Marie Woeste, Mantorville, MN (US)

Correspondence Address: Robert R. Williams;IBM Corporation, Dept. 917, 3605 Highway 52 North, Rochester, MN, 55901-7829, US

(21) Appl. No.: 12/019,703

(22) Filed: Jan. 25, 2008

(51) Int. Cl. G06G 7/18

(52) U.S. Cl. 327/335

(57) ABSTRACT

A method and apparatus to equalize currents on a matching pair of FETs having sources connected together on a silicon on insulator semiconductor chip, or other chip wherein FET bodies can be individually biased. During a determination period, functional inputs coupled to the gates of the matching pair of FETs are short circuited, and a DAC adjusts a first body voltage of a first FET in the matching pair of FETs relative to a second body voltage of a second FET in the matching pair of FETs until a currents in the first FET and the second FET are equal, within resolution of the DAC's voltage granularity. A proper DAC control value is stored and applied to the DAC following the determination period when the short circuit is removed from the functional inputs.

### CROSS-REFERENCE TO RELATED APPLICATION

This application is related to co-pending U.S. Patent application entitled “Design Structure for Apparatus for Improvement of Matching FET Currents Using a Digital to Analog Converter” filed on __/__/08, by Steven J. Baumgartner, et al, having Attorney docket # ROC920080023US1 and accorded serial number [__/___,___].

### CONTRACTUAL ORIGIN OF THE INVENTION

This invention was made with United States Government support under Agreement No. HR0011-07-9-0002 awarded by DARPA. The Government has certain rights in the invention.

### FIELD OF THE INVENTION

This invention relates generally to Silicon On Insulator (SOI) Field Effect Transistors (FET) or FETs on a triple well process or other semiconductor process in which FET bodies can be independently biased. More particularly, this invention relates to improving matching of currents of a matching pair of FETs.

### SUMMARY OF THE EMBODIMENTS OF THE INVENTION

Many modern electronic systems, such as computers, personal digital assistants (PDA) and the like contain silicon on insulator (SOI) semiconductor chips. A Field Effect Transistor (FETs) on SOI has a gate, a drain, a source, and a body. In SOI, the body of an FET is normally floating (i.e., having no low resistance DC connection to anything). Leakage to the body from reverse-biased junctions does occur, and, if the body voltage becomes high enough (in an N-channel FET (NFET)) relative to the source, or low enough (in a P-channel FET (PFET)) relative to the source), carriers will flow through the forward biased junction until the junction is no longer forward biased. It will be noted that other semiconductor processes, such as a triple well process, may also provide FET body isolation, and the apparatus and methods described herein also apply to such other semiconductor processes. SOI will be used for exemplary purposes herein.

It is possible to connect an FET body to a signal or a voltage supply on an SOI chip through well known connections, called body contacts, so that the FET body of any particular FET can be set to a particular voltage.

A differential circuit is a circuit that produces an output based on a difference of voltage between a first functional input and a second functional input.

A differential circuit uses pairs of FETs that are required to have very closely matching characteristics; these FETs are called matching pairs. Matching pairs are used in various differential circuits, for examples, differential amplifiers, differential receivers, sense amplifiers used with SRAMS (static random access memory), sense amplifiers used with DRAMs (dynamic random access memory) and the like. Matching pairs FETs are designed to have the same width and the same length. Process tolerance (width variation, length variation, doping variation in the semiconductor) causes imperfect matching. In particular, slight differences in channel lengths or doping can cause a first threshold voltage in a first FET in the matching pair to differ from a second threshold voltage in a second FET in the matching pair. Current in an FET changes slightly with small changes in channel length and/or threshold voltage. Process related FET mismatches in a matching pair of FETs can cause, for example, a differential receiver to be incapable of receiving a high speed differential signal that would be correctly received in absence of the process related mismatches in the matching pair of FETs.

Process related mismatch can be reduced by designing both FETs in the matching pair with channel lengths significantly longer than a minimum channel length specified in a technology; however designing FETs with longer channel lengths significantly reduces performance, since, to a first order, other design parameters equal, current in an FET decreases with increasing channel length. Undesirable parasitic elements, such as capacitance, increase as channel length is increased, for a given amount of current capability in an FET.

In an embodiment of a differential circuit according to the present invention, a digital to analog converter (DAC) independently controls voltage of a first body in a first FET in a matching pair, and of a second body in a second FET in the matching pair. A first source in the first FET is connected to a second source in the second FET. A controller determines a proper DAC control value with which to control the DAC such that, when the first functional input of the differential circuit and the second functional input of the differential circuit are logically shorted together, a first current in the first FET matches a second current in the second FET to the degree possible, given a granularity of the DAC.

Ideally, the first current and the second current would be exactly the same when the first and second functional inputs are logically shorted together. In practice, embodiments of the invention match the first and second currents as well as can be done given granularity of the DAC used. For example, if a five bit DAC is used, thirty two different FET body voltage combinations can be provided, which provides a relatively close matching of the first and second currents. If a two bit DAC is used, only four different FET body combinations can be provided, which provides a relatively coarse matching of the first and second currents.

During a determination period during which determination of the proper DAC control value is performed, the first and second functional inputs of the differential circuit are shorted together. The first and second functional inputs are coupled through a switch, and, perhaps an amplifier, to a first gate of the first FET and to a second gate of the second FET. A reference current is coupled to the sources of the first and second FETs, or, in an alternative embodiment, the sources of the first and second FETs are shorted to a supply voltage such as ground. The controller chooses an initial value of the DAC control value, and the controller is configured to check whether the first FET or the second FET conducts more current. In an embodiment, the controller makes the determination by incrementing or decrementing a DAC control value. The DAC control has a number of bits dependent upon the DAC. For example, a DAC capable of outputting thirty two voltages would have five bits in the DAC control. When a change is detected in which of the two FETs (first FET or second FET) of the matching pair conducts more current, the current value of the DAC control value is stored as the proper DAC control value. Storage may be to an SRAM (static random access memory), a DRAM (dynamic random access memory), one or more latches, a register, an electrically programmable fuse, a FLASH memory, a magnetic disk, a CDROM, a DVD, or the like. In an alternative embodiment, the controller makes the determination by performing a binary search of DAC control values until a proper DAC control value is selected that best matches currents through the first FET and the second FET. As before, the proper DAC control value is stored.

Determination of the proper DAC control value may be made during manufacturing of the SOI chip if a nonvolatile storage is available on the SOI chip. Electronically programmable fuses are often available on SOI chips, for example. Alternatively, the proper DAC control value may be determined during manufacture of an electronic system comprising the SOI chip, the proper DAC control value stored in any nonvolatile storage that exists in the electronic system. The proper DAC control value may also be determined during bring up of the electronic system in a user environment, with storage of the proper DAC control value being SRAM, DRAM, or any other storage in the electronic system.

After determination and storage of the proper DAC control value, the controller reconnects the gates of the matched pair of FETs to functional inputs and drives the proper DAC control value to the DAC.

### BRIEF DESCRIPTION OF THE DRAWINGS

FIG. 1A is a block diagram of an SOI chip having a matching pair of FETs and a DAC configured to match the threshold voltages of the matching pair of FETs.

FIG. 1B is a variant implementation of a portion of FIG. 1A.

FIG. 1C is a variant implementation of the block diagram of FIG. 1A, including an amplifier.

FIG. 2A is double pole, double throw switch suitable for connecting gates of a matching pair of FETs together in a first position, and connecting each gate of the matching pair of FETs to a separate input in a second position.

FIG. 2B is a schematic of circuitry on an FET chip configured to implement the double pole, double throw switch of FIG. 2A.

FIG. 2C is a schematic of circuitry on an FET chip configured to implement the double pole, double throw switch of FIG. 2A.

FIG. 3 is a schematic of a DAC suitable for use in the block diagram of FIG. 1A.

FIG. 4 is a schematic of a DAC similar to that shown in FIG. 3, but including additional circuitry to ensure that body to source junctions in the matching pair of FETs do not become forward biased.

FIG. 5A is a flow chart of a method embodiment of the invention that determines a proper value for the DAC control value.

FIG. 5B is a flow chart showing details of an incremental search scheme usable in the flow chart of FIG. 5A.

FIG. 5C is a flow chart showing details of a binary search scheme usable in the flow chart of FIG. 5A.

FIG. 6 is a drawing showing a data structure embodiment of the invention.

### DETAILED DESCRIPTION OF THE EMBODIMENTS

In the following detailed description of embodiments of the invention, reference is made to the accompanying drawings, which form a part hereof, and within which are shown by way of illustration specific embodiments by which the invention may be practiced. It is to be understood that other embodiments may be utilized and structural changes may be made without departing from the scope of the invention.

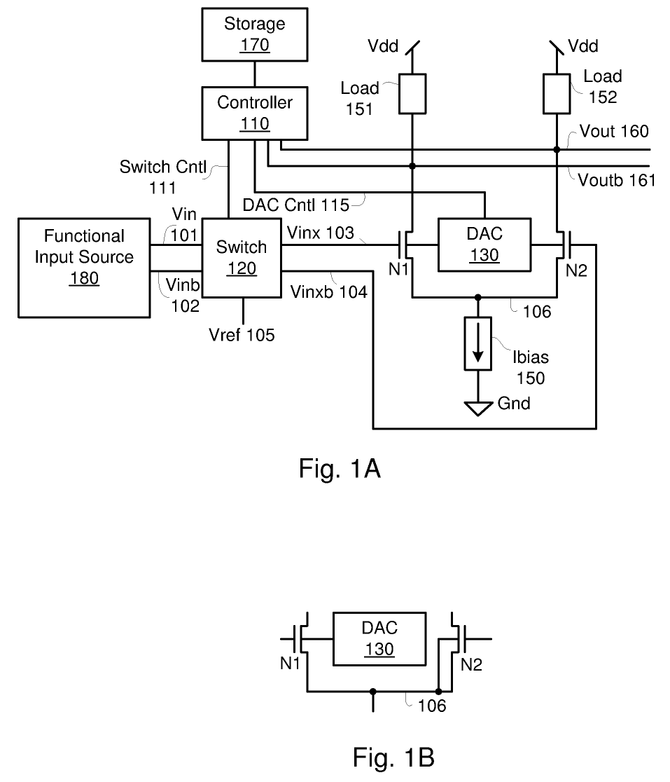

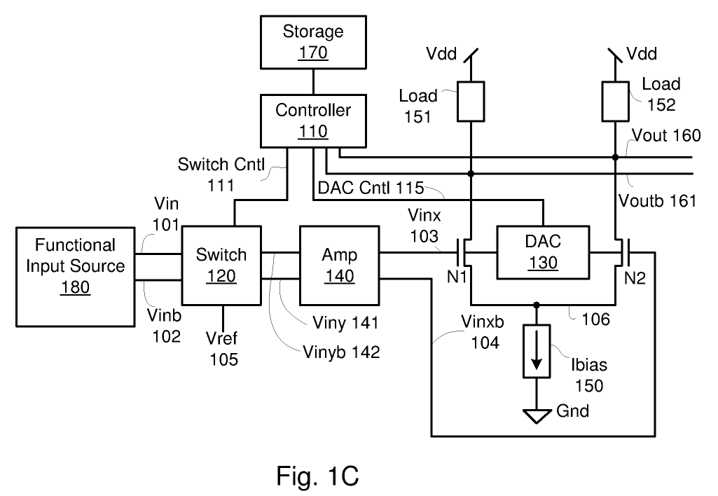

With reference now to the drawings, and, in particular, FIG. 1A, a portion of a silicon on insulator (SOI) semiconductor chip is shown. In brief, a functional input source is shown driving a differential signal having a first functional input and a second functional input to a differential circuit, the differential circuit comprising a double pole double throw switch, a matching pair used in a differential amplifier, and, in an extension shown in FIG. 1C, amplification between the double pole double throw switch and the differential amplifier. A digital to analog converter (DAC) drives body voltages to a first and second FET in the matching pair. A controller senses an output of the differential amplifier and, when the first and second functional input are logically shorted during a determination period, controls the DAC to adjust the body voltages of the matching pair such that currents in the first and second FET are equal, to within a voltage granularity of the DAC. A detailed description of apparatus and method is given below.

FIG. 1A shows a functional input source 180. Functional input source 180 may be on the semiconductor chip or may be a separate electronic component, such as a different semiconductor chip. Semiconductor chip drives a first functional input Vin 101 and a second functional input 102.

A matching pair of field effect transistors (FETs), N1 and N2 is designed such that N1 and N2 have the same widths and lengths and are as identical as possible in all design respects. Processing variations cause width, length, and doping to statistically differ slightly between N1 and N2, such that under identical voltage conditions on all nodes N1 and N2 conduct slightly different currents.

While N1 and N2 are shown as n-channel FETs (NFETs) for exemplary purposes in FIG. 1A, those skilled in the art will understand that p-channel FETs may also be used for matching pairs, with other circuitry and biasing described herein altered appropriately from the NFET examples described herein.

In FIG. 1A, N1 and N2 are connected together at their sources at node 106. Node 106 may be coupled to a bias current Ibias 150, such that N1 and N2 share bias current from Ibias 150. Alternatively, Ibias 150 may be simply a switch that, when closed, couples node 106 directly to ground (or other suitable voltage supply), in which case, current in N1 and N2 are independent of each other and current in N1 and N2 depend primarily upon gate voltages on a gate of N1 and a gate of N2. Processing variations will still cause small differences in channel length and threshold, and therefore, currents in N1 and N2 will not be identical, given identical gate, source, drain, and body voltages on N1 and N2. A drain on N1 is coupled to a load 151 which may be a resistor, another FET, or other electrical element across which voltage changes with changing current through the electrical element. Similarly, a drain on N2 is coupled to a load 152.

As shown in FIG. 1A, N1 and N2 are matching pair FETs in an exemplary differential amplifier configuration which, in functional operation, receives functional inputs Vin 101 and Vinb 102 and outputs Vout 160 and Voutb 161. When the voltage of node Vinx 103 is greater than the voltage of node Vinxb 104, Vout 160 is expected to be greater than Voutb 161.

A body of N1 and a body of N2 are coupled to DAC (digital to analog converter) 130, using any of a number of well-known body contacts usable in SOI technology.

It is well known that current in an FET is a function of threshold voltage of the FET. As threshold voltage decreases (in absolute magnitude) current in the FET will increase, other conditions not changing.

As is also well known, FET threshold voltages are a function of source to body voltage. For simplicity (modern, very short-channel FETs include additional terms), approximate equation 1 shows a square root function between source to body voltage and threshold voltage:

VTN=VTO+G*(sqrt(VSB+2φF)−sqrt(2*φF)) (1)
Where VTN is the threshold voltage
   VTO is the threshold voltage for zero source to body voltage
   G is the body effect parameter
   VSB is the source to body voltage
   2*φF is the surface potential

The circuitry shown in FIG. 1A is configured to control body voltages of N1 and N2 such that, when Vinx 103 and Vinxb 104 are equal, N1 and N2 have currents that are equal (subject to granularity of DAC 130).

A controller 110 is coupled to Vout 160 and Voutb 161. Controller 110 is configured to sense whether Vout 160 or Voutb 161 is of higher voltage. Controller 110 is further coupled via DAC control 115 to DAC 130. DAC control 115 has a number of signal conductors appropriate for DAC 130. For example, if DAC 130 can output 32 different voltages, DAC control 115 would have five signal conductors (or ten signal conductors if true and complement of each logical signal are included). It is understood that controller 110 may be coupled to Vout 160 and Voutb 161 through additional stage(s) of amplification. For example, Vout 160 and Voutb 160 may be passed through additional stages of differential amplifiers, outputs of such additional differential amplifiers being connected to controller 110, with appropriate phase. Direct connection of Vout 160 and Voutb 161 to controller 110 is shown for simplicity of illustration and description.

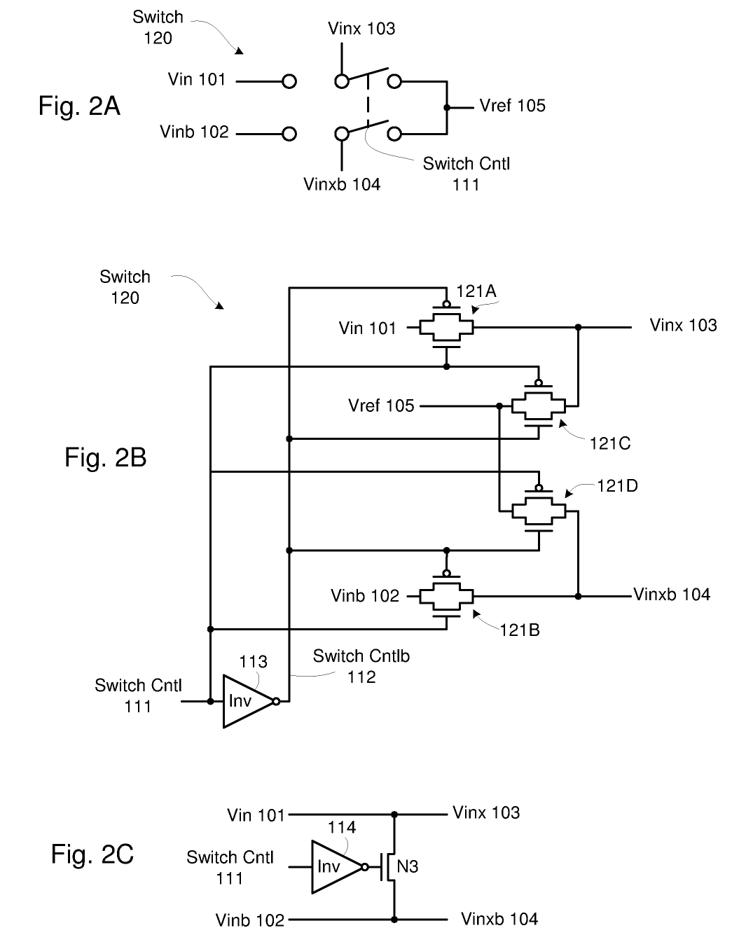

A switch 120 couples functional input signals Vin 101 and Vinb 102 to Vinx 103 and Vinxb 104, respectively, upon an active signal on switch control 111 sent from controller 110. If switch control 111 is inactive, Vref 105 is coupled to both Vinx 103 and Vinxb 104, logically shorting the functional inputs from the point of view of circuitry receiving Vinx 103 and Vinxb 104. Switch 120 is described in more detail later with reference to FIGS. 2A and 2B.

A voltage value of Vref 105 needs to be within a common mode operating range of voltage on Vin 101 and Vinb 102. For example, if Vin 101 switches between 0.9 volts and 1.1 volts (while Vinb 102 switches from 1.1 volts to 0.9 volts), a suitable value for Vref 105 is 1.0 volts. However, Vref 105 may be any voltage that allows the matching pair N1, N2 to operate properly for their intended use (differential receiver, sense amplifier, etc).

Controller 110 is configured to determine a proper DAC control value (i.e., a value sent from controller 110 to DAC 130 over DAC control 115 that causes N1 and N2 to conduct matching currents when Vinx 103 and Vinxb 104 have the same value, within the granularity of voltages that DAC 130 is capable of producing). During an interval when controller 110 is determining the proper DAC control value, controller 110 makes switch control 111 inactive, coupling Vref 105 to both Vinx 103 and Vinxb 104.

Ideally, the first currents in N1 and N2 would be exactly the same when the first and second functional inputs are logically shorted together. In practice, embodiments of the invention match the currents of N1 and N2 as well as can be done given granularity of the DAC 130 used. For example, if a five bit DAC is used, thirty two different FET body voltage combinations can be provided, which provides a relatively close matching of the currents of N1 and N2. If a two bit DAC is used, only four different FET body combinations can be provided, which provides a relatively coarse matching of the currents of N1 and N2.

Upon determining the proper DAC control value, controller 110 stores the proper DAC control value in storage 170. Storage 170 may be implemented in SRAM, DRAM, latches, registers, or other volatile storage, or nonvolatile storage such as electrically programmable fuses, FLASH memory, magnetic disk, CDROM, DVD, and the like.

After determining, during the determination period, and storing the proper DAC control value, controller 110 activates switch control 111, thereby coupling Vin 101 to Vinx 103, and Vinb 102 to Vinxb 104. Controller 110 also then drives the proper DAC control value on DAC control 115 to DAC 130.

Determination of the proper DAC control value may be done during manufacture of the SOI chip, if storage 170 is nonvolatile storage and is implemented on the SOI chip. A number of electrically programmable fuses would be a suitable storage 170 in applications wherein the proper DAC control value is determined during manufacture of the SOI chip. FLASH memory or laser fusing on or coupled to a package containing the SOI chip may also be used to store the proper DAC control value when the proper DAC control value is determined during manufacturing.

Determination of the proper DAC control value may be done during manufacture of an electronic system comprising the SOI chip. Additional implementations of storage 170 are possible then, including implementing storage 170 on magnetic disk, CDROM, DVD, or other nonvolatile storage media, as available in the electronic system.

Determination of the proper DAC control value may be done during bring up of the electronic system comprising the SOI chip. SRAM, DRAM, a register, or other volatile storage media may be used to implement storage 170, along with the implementations described earlier, since the proper DAC voltage will be re-determined each time the electronic system is powered up.

Determination of the proper DAC control value may be periodically done while the electronic system is powered up. Normal use of the matching pair (N1, N2 in the exemplary differential amplifier) is halted, switch control 111 is made inactive, and controller 110 determines a proper DAC control value and stores the proper DAC control value in storage 170. Periodically determining the proper DAC control value may be useful if threshold values shift due to environmental changes, such as temperature.

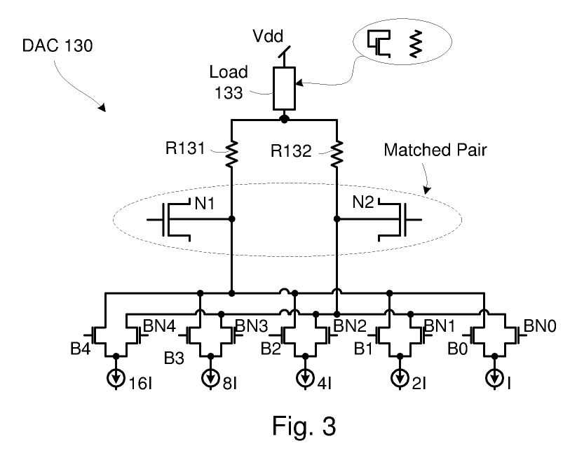

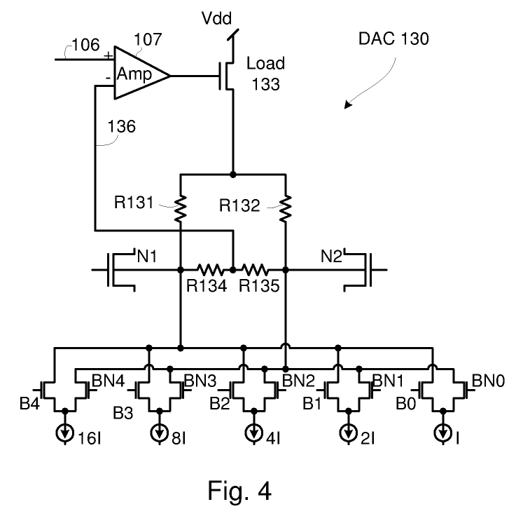

In FIG. 1A, DAC 130 is shown to be coupled to both the body of N1 and the body of N2. In an exemplary DAC 130 shown in FIGS. 3 and 4 and described later, DAC 130 simultaneously changes, in a first direction, a voltage on the body of N1 and changes, in an opposite direction, a voltage on the body of N2. Other implementations are possible. For example, FIG. 1B (showing only DAC 130, N1, N2, and node 106) shows the body of N2 coupled to node 106 and DAC 130 controlling only the voltage on the body of N1, again causing the body voltage of N1 to be adjusted versus the body voltage of N2. The same implementation of DAC 130 may be used in the embodiment of FIG. 1B as was used in FIG. 1A. Other DAC 130 implementations known to those of skill in the art may be used in the embodiment of either FIG. 1A or FIG. 1B, with the exemplary embodiment of DAC 130 shown in FIGS. 3 and 4 used for explanation only.

FIG. 1C shows an extension to the embodiment of FIG. 1A, the extension providing one or more stages of amplification of the functional signals Vin 101 and Vinb 102 between switch 120 and the matching pair of FETs, N1 and N2. In FIG. 1C, switch 120 outputs signals Viny 141 and Vinyb 142. Switch 120 will switch functional inputs Vin 101 to Viny 141, and Vinb 102 to Vinyb 142, if switch control 111 is active. If switch control 111 is inactive, switch 120 connects both Viny 141 and Vinyb 142 to Vref 105. Amplifier 140 amplifies signals Vinyl 41 and Vinyb 142 (or the difference between Viny 141 and Vinyb 142) and drives Vinx 103 and Vinxb 104, as depicted in FIG. 1C. Circuitry in amplifier 140, like matching pair of FETs N1 and N2, may also have mismatching.

In FIG. 1C, when switch control 111 is inactive, Vref 105 is driven through amplifier 140 to matching pair of FETs N1 and N2. Controller 110 operates as explained earlier, to match, within granularity of DAC 130, currents in N1 and N2 when Vref 105 is coupled to both inputs of amplifier 140. Therefore, mismatches in both amplifier 140 and matching pair of FETs N1 and N2 are compensated for. In this embodiment, when switch control 111 is inactive (shorting Viny 141 to Vinyb 142 and connecting the shorted node to Vref 105), Vinx 103 and Vinxb 104 may not be at the same voltage, because of possible mismatching of circuitry in amplifier 140. However, controller 110, via DAC 130, ensure that, when Viny 141 and Vinyb 142 are at the same voltage (that is, at Vref 105 when switch control 111 is inactive, or functional inputs Vin 101 and Vinb 102 are at the same voltage), currents in N1 and N2 are equal, within granularity of DAC 130.

FIG. 2A shows a DPDT (double pole double throw) switch schematic that, in various implementations, is suitable for switch 120 (FIG. 1A). Vinx 103 and Vinxb 104, depending on switch control 111, are respectively connected to Vref 105, or, to Vin 101 and Vinb 102. In the position shown, for example, Vref 105 is connected to both Vinx 103 and Vinxb 104. In the opposite position, Vinx 103 is connected to functional input Vin 101 and Vinxb 104 is connected to functional input Vinb 102. It will be appreciated that, since there is no appreciable resistance in switch 120, short circuiting Vinx 103 to Vinxb 104 is equivalent to, when switch control 111 is active, Vin 101 and Vinb 102 both being at a same particular voltage. When switch control 111 is inactive, therefore, functional inputs Vin 101 and Vinb 102 are logically short circuited from the view of the matching pair of FETS N1 and N2 (and amplifier 140 of FIG. 1C).

For purposes of definition, when switch control 111 is inactive, functional inputs Vin 101 and Vinb 102 will be deemed to be logically short circuited.

FIG. 2B shows a CMOS (complementary metal oxide semiconductor) implementation of switch 120 suitable for use on an SOI chip. Switch control 111 (described earlier with reference to FIG. 1A) is inverted by inverter 113 to produce an inverted version of switch control 111, switch control b 112. A first pair of pass gates 121 (shown as 121A, 121B) couple Vin 101 and Vinb 102 to Vinx 103 and Vinxb 104, respectively, when switch control 111 is “1”. When switch control 111 is “0”, a second pair of pass gates 121 (shown as 121C, 121D) couple Vref 105 to both Vinx 103 and Vinxb 104. Switch 120 of FIG. 2B is fully usable as in the circuitry of FIG. 1C, to logically short circuit functional inputs Vin 101 and Vinb 102 when switch control 111 is inactive.

FIG. 2C shows another implementation of switch 120 that is usable when Vin 101 and Vinb 102 are driven by relatively high resistance sources (i.e., high impedance outputs of functional input source 180 of FIG. 1A). If functional input source 180 is a relatively low impedance source for Vin 101 and Vinb 102, such as a differential transmission line driver intended to drive 50 ohm transmission lines on a printed circuit board, the implementation of FIG. 2C is unlikely to be practical. When switch control 111, in FIG. 2C, is “1” (active), NFET N3 is “off”, and Vinx 103 is exactly Vin 101; and Vinxb 104 is exactly Vinb 102. However, when switch control 111 is “0” (inactive), inverter 114 drives a gate of N3 high. N3 is sized to be of much lower impedance than source impedances of Vin 101 and Vinb 102, effectively functionally, as well as logically, short circuiting functional inputs Vin 101 and Vinb 102. Vref 105, in this implementation is the common mode voltage of Vin 101 and Vinb 102 when functionally short circuited. It is understood that, in the simple circuit shown in FIG. 2C, that N3 can never be a “perfect short circuit”. Some current will flow through N3, causing a small voltage difference between a source of N3 and a drain of N3. To accommodate this small voltage difference, if controller 110 is configured to control a phase of the functional input source 180 of Vin 101 and Vinb 102, controller 110 can determine a first proper DAC control value when Vinb 101 is higher than Vinb 102 (when shorted by N3), and a second proper DAC control value when Vinb 101 is lower than Vinb 102 (when shorted by N3), and then averaging the first and second proper DAC control value as the stored proper DAC control value. Vref 105, in the implementation of FIG. 2C, is simply the “voltage divided” outputs from functional input source 180. For example, assume that Vin 101 and Vinb 102 are each driven by equal impedance sources, and (for simplicity), N3 impedance is “zero”. Further assume that, if Vin 101 and Vinb 102 are each open circuited, and that, when open circuited, Vin 101 is at 1.1 volts, and Vinb 102 is at 0.9 volts, then the voltage divided result for Vref 105 is 1.0 volts.

FIG. 3 shows an embodiment of DAC 130, having five bits (B0, B1, B2, B3, B4) and their complements (BN0, BN1, BN2, BN3, BN4) sent from controller 110 on DAC control 115. A five bit DAC is used for illustration only; DACs controlled by one bit to an arbitrarily large number of bits are contemplated. Five current sources, I, 2I (i.e., two times the current of current source I), 4I, 8I, and 16I are provided as depicted. Such current sources are well known in the art, and are easily generated from a single reference current, with current mirror FETs having widths, respectively, of multiples 1, 2, 4, 8, and 16 times the width of the reference current FET. Signal B4 (and its complement, BN4) switch current source 161 to resistor R131 (if B4 is “1”) or to resistor R132 (if B4 is “0”). Likewise, B3 switches current source 81 between R131 and R132; B2 switches current source 41 between R131 and R132; B1 switches current source 21 between R131 and R132; B0 switches current source 11 between R131 and R132. If B0, B1, B2, B3, and B4 are all “1”, then 31 units of current flow through R131 and no current flows through R132. Advantageously, R131 has the same resistance value as R132, so that the body voltage of N1 goes up (or down) the same amount that the body voltage of N2 goes down (or up). Load 133 primarily determines a common mode body voltage of N1 and N2. Load 133 may be, as shown, an FET or a resistor. For example, assuming, for simplicity that load 133 is a resistor, and that R131=R132, the common mode body voltage of N1 and N2 is Vdd−31*I*(load 133+R131/2).

FIG. 4 shows an embodiment of DAC 130 as depicted in FIG. 3, but includes a control loop configured for control of the common mode body voltage of N1 and N2 to be at the voltage on node 106 (FIG. 1A). Resistors R134 and R135 are connected as shown. R134 and R135 are high valued resistors compared to R131 and R132 in order to not appreciably reduce gain in DAC 130. For example, if R134 and R135 are very low valued resistors, voltage across the series combination of R134 and R135 will not be great, and DAC 130 will not be able to provide much voltage difference between the bodies of N1 and N2. R134 is designed to have the same resistance value of R135.

Node 136 is the common mode body voltage of N1 and N2 (i.e., a voltage halfway between the body voltage of N1 and the body voltage of N2). Node 136 is coupled to a first input of a differential amplifier 107. Differential amplifier 107 also receives, on a second input, node 106 which is coupled (FIG. 1A) to the sources of N1 and N2. Differential amplifier 107 drives an FET embodiment of load 133 as depicted, controlling load 133 to provide a voltage that makes node 136 equal to node 106. For example, if node 136 begins to rise in voltage, the output of differential amplifier 107 will fall, lowering the gate voltage of load 133 and thereby lowering node 136 which completes the negative feedback for the control loop. Other choices for a common mode voltage of the bodies of N1 and N2 are contemplated, the voltage of node 106 being just one example for purposes of explanation.

After determining the proper DAC control value and storing the proper control value in storage 170, controller 110 activates switch 120, thereby coupling functional inputs Vin 101 and Vinb 102 to gates of N1 and N2 (through an amplifier in some embodiments as described earlier), and drives the proper DAC control value on DAC control 115 to DAC 130.

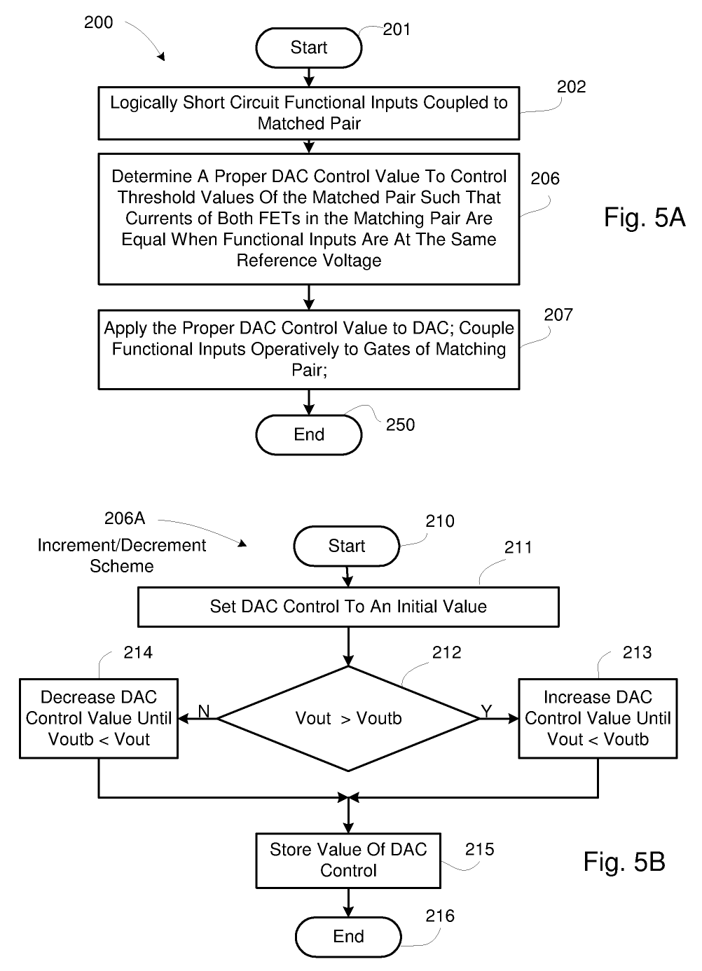

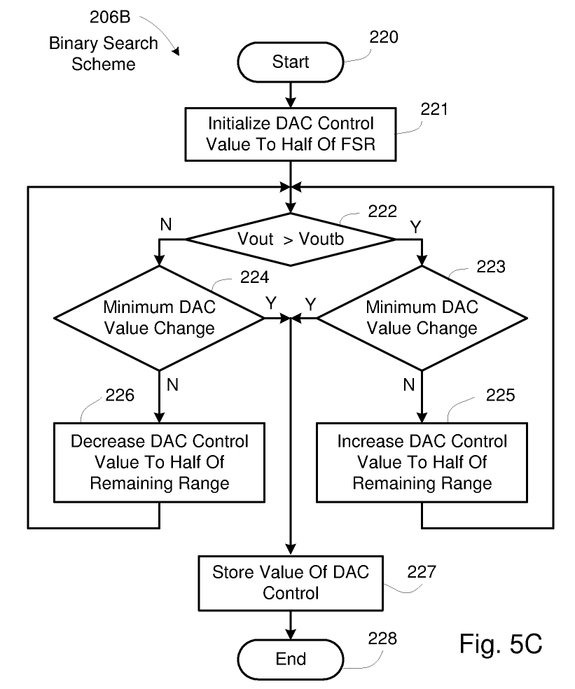

Embodiments of the invention can be expressed as methods. FIG. 5A is a high level flow diagram of a method 200 embodiment of the invention. Method 200 begins at block 201. In block 202, functional inputs are coupled, perhaps through an amplifier, such as is shown in FIG. 1C) to a matching pair of FETs (such as N1 and N2 in FIG. 1A). The functional inputs are logically shorted together while a proper DAC control value is determined. A reference voltage (e.g., Vref 105 of FIG. 1A) is coupled to the FET gates. In block 206, a proper DAC control value is determined to adjust threshold voltages of the matching pair of FETs, such that current through the matching pair is equal (within granularity of the DAC used) when the functional inputs are logically shorted together (as explained earlier, when the outputs of switch 120 of FIG. 1A or 1C are at the same voltage). Block 207 applies the proper DAC control value to the DAC and couples the functional inputs operatively (i.e., removes the logical short circuit) to the gates of the matching pair of FETs (possibly through an amplifier stage(s), such as amplifier 180 of FIG. 1C). Block 250 ends method 200.

FIG. 5B shows method 206A, an embodiment of block 206 of FIG. 5A. Method 206A increments (or decrements) through DAC control value values until a change is detected in which FET in the matching pair conducts the most current when the functional inputs are logically shorted together.

Method 206A begins at step 210. In step 211 the DAC control value is set to an initial value. For example, in a DAC that has five logical bits in a DAC control signal (such as DAC control 115 in FIG. 1A), the initial value may be “00000”, and a controller (such as controller 110 in FIG. 1) will, at a rate determined by the designer, increment the DAC control value as described below, until a change is detected in which FET of the matching pair of FETs conducts more current. Alternatively, the initial value may be “11111” and the DAC control value is decremented until a change is detected in which FET of the matching pair of FETs conducts more current. Or, the initial value may be “10000” (or any other value between “00000” and “11111”), and the DAC control value may be monotonically incremented or decremented, depending upon which of the matching pair of FETs initially conducts more current when the gates of the matching pair of FETs have the same voltage. An initial choice of “10000” or “01111” is advantageous since, statistically, the two FETs in the matching pair will be very similar, or even virtually identical, in current, when the functional inputs are at the same voltage, thereby requiring fewer increments (or decrements) to determine the proper DAC control value.

Block 212 determines which of the matching pair of FETs conducts more current when the functional inputs are logically short circuited. Referring to FIG. 1A, and assuming equal loads 151 and 152, if N1 conducts more current than N2, Vout 160 will be at a higher voltage than Voutb 161, and therefore, the threshold voltage of N1 must be increased and/or the threshold voltage of N2 must be decreased.

If the initial value of DAC control value results in Vout>Voutb, (in FIG. 1A and FIG. 1C, N1 needs to have an increased threshold voltage and/or N2 needs to have a lower threshold voltage) control passes to block 213, which increases the DAC control value until Vout<Voutb. See FIG. 3 or FIG. 4, where an increased value of the DAC control value causes relatively more current to flow through R131 versus R132, resulting in a lowered body voltage of N1 versus N2. When N1 has a lowered body voltage versus N2, the threshold voltage of N1 increases, and the threshold value of N2 decreases, reducing current in N1 versus N2. As current in N1 decreases versus N2, Voutb 161 rises and Vout 160 falls.

At a value of DAC control value when a change is first seen as to when FET in the matching pair conducts more current, block 215 stores the present value of DAC control value as the proper DAC control value as described earlier. The immediately preceding DAC control value could be used as the proper DAC control value instead of the present DAC control value, since all that is known is that the “exact” proper DAC control value in fact lies somewhere between the present DAC control value and the immediately preceding DAC control value. It is understood that Vout may be exactly equal to Voutb, however, in practice, gain in control 110 (FIGS. 1A, 1C) will resolve Vout (or Voutb) to be larger. Well known techniques in resolving metastable conditions can be applied to resolve a Vout=Voutb condition.

If the initial value of DAC control value results in Voutb<Vout, control passes to block 214, which decreases the DAC voltage value until Vout>Voutb. At that current DAC control value, the present DAC control value (or the immediately preceding DAC control value, as discussed above) is stored as the proper DAC control value in step 215.

Block 216 ends method 206A.

FIG. 5C provides an alternative method 206B embodiment of block 206 of FIG. 5A. Method 206B provides a “binary search” scheme to determine the proper DAC control value.

Method 206B begins at block 220. In block 221 a DAC control value is initialized to half of the full scale range (FSR). Full scale range is the entire range of DAC control values. “Half” means approximately half, since the full scale range may not be exactly divisible into two equal parts. For example, if the DAC receives a five bit control value as used previously for exemplary purposes, “10000” or “01111” could be used to initialize as an initial DAC control value. Other initial values could be used, but the binary search would statistically take slightly longer if the FSR is not effectively divided in two.

In block 222, a check is made to see if Vout is greater than Voutb.

If block 222 determines that Vout is greater than Voutb, control passes to block 223 which checks to see if a minimum change has already been made to the DAC control value. If so, control passes to block 227 which stores the present (or immediately preceding, as described above) DAC control value as the proper DAC control value. If not, control passes to block 225 which increases the DAC control value to half of the remaining range. For example, if the initial DAC control value was “10000”, the DAC control value would be changed to “11000”. Block 225 then transfers control to block 222.

If block 222 determines that Vout is not greater than Voutb, control passes to block 224, which checks to see if a minimum change has already been made to the DAC control value. If so, control passes to block 227 which stores the present (or immediately preceding, as described above) DAC control value as the proper DAC control value. If not, control passes to block 226, which decreases the DAC control value to half of the remaining range. For example, if the initial DAC control value was “10000”, the DAC control value would be changed to “01000”. Block 226 then transfers control to block 222.

Block 228 ends method 208B.

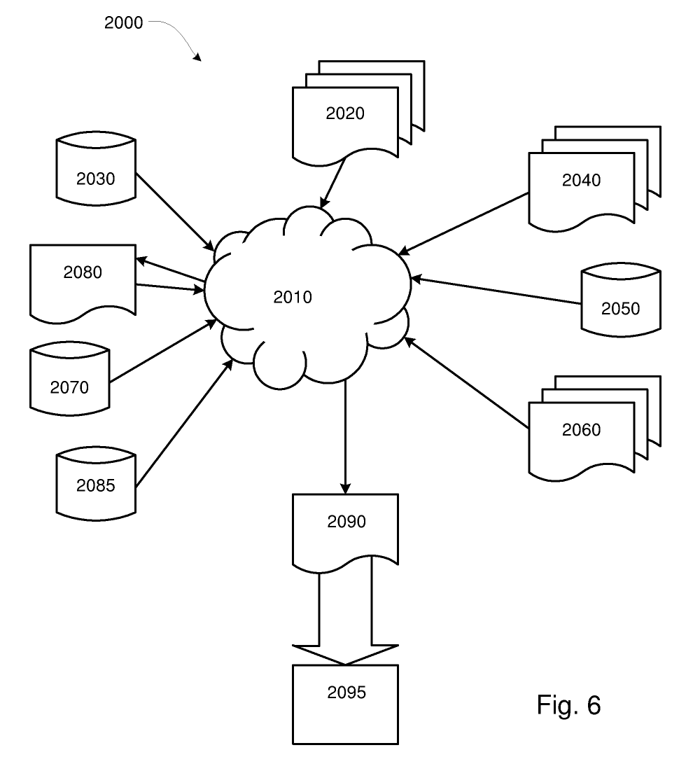

FIG. 6 shows a block diagram of an example design flow 2000 that may be used for the SOI chip having the matching pair of FETs and the associated circuitry to match currents in the matching pair of FETS as described herein. Design flow 2000 may vary depending on the type of integrated circuit being designed. For example, a design flow 2000 for a static random access memory may differ from a design flow 2000 for a dynamic random access memory. In addition, design flow 2000 may differ for different semiconductor processes. Design structure 2020 is preferably an input to a design process 2010 and may come from an IP provider, a core developer, or other design company or may be generated by the operator of the design flow, or from other sources. Design structure 2020 comprises circuits described above, for examples in FIGS. 1A, 1B, 2A, 2B, 3, and 4, in the form of schematics or HDL, a hardware-description language (e.g., Verilog, VHDL, C, etc.). Design structure 2020 may be contained on one or more tangible computer readable medium. For example, design structure 2020 may be a text file or a graphical representation of circuits described above. Examples of tangible computer readable medium include hard disks, floppy disks, magnetic tapes, CD ROMs, DVD, flash memory devices, and the like. Design process 2010 preferably synthesizes (or translates) the circuits described above into a netlist 2080, where netlist 2080 is, for example, a list of wires, transistors, logic gates, control circuits, I/O, models, etc. that describes the connections to other elements and circuits in an integrated circuit design and recorded on the at least one computer readable medium. This may be an iterative process in which netlist 2080 is resynthesized one or more times depending on design specifications and parameters for the circuit.

Design process 2010 may include using a variety of inputs; for example, inputs from library elements 2030 which may house a set of commonly used elements, circuits, and devices, including models, layouts, and symbolic representations, for a given manufacturing technology (e.g., different technology nodes, 32 nm, 45 nm, 90 nm, etc.), design specifications 2040, characterization data 2050, verification data 2060, design rules 2070, and test data files 2085 (which may include test patterns and other testing information). Design process 2010 may further include, for example, standard circuit design processes such as timing analysis, verification, design rule checking, place and route operations, etc. One of ordinary skill in the art of integrated circuit design can appreciate the extent of possible electronic design automation tools and applications used in design process 2010 without deviating from the scope and spirit of the invention. The design structure of the invention is not limited to any specific design flow.

Design process 2010 preferably translates an embodiment of the invention as shown in the various logic diagrams and the underlying circuitry along with any additional integrated circuit design or data (if applicable), into a second design structure 2090. Design structure 2090 resides on a tangible computer readable storage medium in a data format used for the exchange of layout data of integrated circuits (e.g. information stored in a GDSII (GDS2), GL1, OASIS, or any other suitable format for storing such design structures). Design structure 2090 may comprise information such as, for example, test data files, design content files, manufacturing data, layout parameters, wires, levels of metal, vias, shapes, data for routing through the manufacturing line, and any other data required by a semiconductor manufacturer to produce an embodiment of the invention as shown in the logic diagrams in the figures. Design structure 2090 may then proceed to a stage 2095 where, for example, design structure 2090 proceeds to tape-out, is released to manufacturing, is released to a mask house, is sent to another design house, is sent back to the customer, etc.

Furthermore, it should be understood that at least some aspects of the present invention, including those described with reference to FIG. 6, may alternatively be implemented in a program product. Programs defining functions of the present invention can be delivered to a data storage system or a computer system via a variety of tangible signal-bearing media (e.g., a floppy disk, hard disk drive, read/write CD ROM, DVD, optical media), and communication media, such as computer and telephone networks including Ethernet. It should be understood, therefore, in such signal-bearing tangible media when carrying or encoding computer readable instructions that direct method functions in the present invention, represent alternative embodiments of the present invention. Further, it is understood that the present invention may be implemented by a system having means in the form of hardware, software, or a combination of software and hardware as described herein or their equivalent.

What is claimed is:

1. A semiconductor chip comprising a differential circuit further comprising:
a matching pair of FETs comprising a first FET and a second FET, a first source of the first FET coupled to a second source of the second FET, a first body of the first FET and a second body of the second FET configured to have separately controlled body voltages;
a first functional input coupled to a first gate of the first FET, and a second functional input coupled to a second gate of the second FET;
a controller coupled to a first drain of the first FET and a second drain of the second FET; and
a digital to analog converter (DAC) configured to adjust, under control of the controller, a first body voltage of the first body relative to a second body voltage of the second body such that a first current of the first FET matches a second current of the second FET during a determination period during which the first functional input is logically short circuited to the second functional input.

2. The semiconductor chip of claim 1, wherein the semiconductor chip is a silicon on insulator (SOI) chip.

3. The semiconductor chip of claim 1, wherein the semiconductor chip is a triple well chip.

4. The semiconductor chip of claim 1, wherein:
the controller is configured to detect whether a first voltage of a first drain of the first FET is greater than, or less than, a second voltage of a second drain of the second FET.

5. The semiconductor chip of claim 4, further comprising:
a switch, configured to be controlled by the controller, the switch configured to, during the determination period, logically short circuit the first functional input and the second functional input, the switch further configured to, after the determination period, remove the logical short circuit between the first functional input and the second functional input.

6. The semiconductor chip of claim 5, the controller configured to, during the determination period, determine a proper DAC control value, the proper DAC control value being a DAC control value that, within voltage granularity of the DAC, equalizes the first current and the second current.

7. The semiconductor chip of claim 6, further comprising a storage, the controller configured to store the proper DAC control value in the storage.

8. The semiconductor chip of claim 6, the controller configured to:
perform an incremental search scheme to determine the proper DAC control value.

9. The semiconductor chip of claim 4, the controller configured to:
perform a binary search scheme to determine the proper DAC control value.

10. The semiconductor chip of claim 1, the DAC configured to, responsive to a change in value of a DAC control value sent from the controller, change the first body voltage by a particular amount and change the second body voltage by the particular amount in the opposite direction.

11. The semiconductor chip of claim 1, the DAC configured to, responsive to a change in value of a DAC control value sent from the controller, change the first body voltage by a particular amount, the second body coupled to a source on the second FET.

12. The semiconductor chip of claim 1, the DAC configured to control a common mode voltage of the first body voltage and the second body voltage to a particular voltage.

13. The semiconductor chip of claim 12, the particular voltage being a voltage of the first and second source.

14. The semiconductor chip of claim 1, the first functional input and the second functional input respectively coupled to the first and second gate through an amplifier.

15. The semiconductor chip of claim 1, the first current matching the second current within a voltage granularity of the DAC, during the determination period

16. A method for overcoming process mismatches in a differential circuit having a
first functional input and a second functional input, the differential circuit having a first FET and a second FET of a matching pair of FETs on a semiconductor chip, the semiconductor chip allowing separate voltage control of a first body on the first FET and a second body on the second FET comprising:
during a determination period, logically short circuiting the first functional input and the second functional input;
coupling a source of the first FET and a source of the second FET together; and
during the determination period, determining a proper DAC value input to a digital to analog converter (DAC) that drives a first body voltage on the first FET relative to the second body voltage on the second FET, the proper DAC value controlling the first FET and the second FET to conduct matching currents.

17. The method of claim 16, further comprising, when the proper DAC value is
determined, storing the proper DAC value in a storage and ending the determination period.

18. The method of claim 16 further comprising:
after the determination period is ended:
removing the logical short circuit between the first functional input and the second logical input; and
driving the proper DAC control value to the DAC.

19. The method of claim 16, using an incremental search in the determining of the
proper DAC control value.

20. The method of claim 16, using a binary search in the determining of the proper
DAC control value.

21. The method of claim 16, wherein matching is determined by voltage granularity
of the DAC.
